(19) United States
(12) Patent Application Publication
(10) Pub. No.: US 2010/0241671 A1
(43) Pub. Date: Sep. 23, 2010

(54) Mode of Operation, Data Model, and System

(75) Inventor: Robert Bosman, Baarn (NL)

Correspondence Address: THE WEBB LAW FIRM, P.C., 700 KOPPERS BUILDING, 436 SEVENTH AVENUE, PITTSBURGH, PA, 15219, US

(73) Assignee: RB HOLDING BV, Baarn (NL)

(21) Appl. No.: 12/376,385

(22) PCT Filed: Aug. 6, 2007
(86) PCT No.: PCT/NL2007/000194

§ 371 Date: May 12, 2009

(30) Foreign Application Priority Data
Aug. 4, 2006 (NL) 1032274

(51) Int. Cl. G06F 17/30

(52) U.S. Cl. 707/805; 707/E17.044; 707/802; 707/E17.005

(57) ABSTRACT

The present invention relates to a method for the storage and accessing of data in a data model, comprising steps for: providing a data processing environment; providing the data model; providing access to one or more of the computer systems that can be mutually linked, where the data model comprises: data with regard to entities, such as persons, for the storage thereof in a entity storage space; data with regard to sets of entities; data with regard to positions, such as roles or tasks, where a position is related to a group, being a set of entities and where the data with regard to a position comprise: at least one e-f-data space for an entity, and at least one g-f-data space for a group for the linking of the position to a group; data with regard to authority, like logical activities such as changing, creating or deleting, which are related to positions.

The present invention relates to a method for the saving of and getting access to data in a data model. Furthermore the invention relates to a method to save or access data in a data model by means of one or more computer systems that can be mutually connected. Also, the invention relates to a data model for use in such a way that is in accordance with the present invention. And then, the present invention relates to the system for the saving of and getting access to data in a data model.

Data computer systems are used in general for saving and processing of data. Large amounts of data can be processed in an efficient way with this. Such systems, for example, are suited for keeping data regarding people. The rights for the eventual changing of data are hereby linked to people. A disadvantage of having a computer system function like this is that the rights are managed by the system administrators of the computer systems.

Because of this, it is, for example, necessary that, when changing the rights of a person, such rights are modified by a management department of the computer system. Such a method has, among others, the disadvantage that changes can only be carried out upon request, when all necessary data are known and have been edited correctly to the management department. Because of this it happens that changes are implemented incorrectly or too late.

The method as described in the above is e.g. implemented in a technical manner in a UNIX system. In such a system, it is recorded for a user, group to which the user belongs and others, which rights are applicable. These rights are recorded separately for security of the system. This method of security has a number of disadvantages among which the rigid documentation as attributes of files or directories.

Data spaces or data storage spaces are defined as ways of storing data, such as in files, directories, tables, normalisations of tables, and/or objects. This is dependent of the implementation of a system according to the present invention.

In order to overcome such disadvantages, the present invention supplies a method for one or more computer systems that can be mutually connected, each comprising processing and saving means, comprising a number of saving spaces such as tables or normalisation of tables, saving and accessing data in a data model, including steps for:
providing a data processing environment for the computer systems that can be mutually connected to carry out the mode of operation;
providing the data model;
providing access to one or more computer systems that can be mutually connected, at which the data model includes:
data with regard to entities, such as persons, for the storing thereof in an entity storage space;
data with regard to sets of entities, for the storing thereof in a group storage space;
data with regard to positions, such as roles or tasks, for the storage thereof in a position storage space, at which a position relates to a group, being a set of entities and at which the data with regard to a position include:
   at least one e-f-data space (entity-function data space) for an entity for linking a position to an entity, and
   at least one g-f-data (group-function data space) space for a group for linking a position to a group;
data with regards to qualifications, such as logical actions as changing, creating or deleting, which are related to positions for storage thereof in a qualifications storage space. An advantage of such a method is that the functions in the group comprise in them the rights to change, because of which these can exist without having a person coupled to them already. Systems according to the state of the art do not have such functionality. Because of this, a function can already exist before an entity is coupled to it according to the present invention. A function within the group can have the right to initiate other functions or groups. Because of this, such a system can always be up to date based on the input of users within the framework of the rights of their functions.

By applying such a method various advantages can be realised. An advantage of such a method in accordance with the present invention is that the positions can be created within a group. At this applies that many positions can be linked to a group. Furthermore it is possible that an entity is linked to many positions. An example of this is that a number of positions can be linked to one person. Also, the rights can be linked to the position in the proportion of many to many. This results in further advantages.

Such further advantages include the property that positions can be created and maintained without the functionary being known, since the position is linked to a group. Such a group is for example a department of a company, or the participants in a committee. Such a department generally has a manager and a number of employees, each holding positions that are specific to that department. The entire group and each of the positions with the corresponding rights can be defined without the functionary or the person incumbent being known as such. Subsequently an entity, such as an employee, can be linked to a position in an easy way. By means of such a linking action this functionary automatically obtains all permissions and knowledge in the information system, which is relevant to that position. As will be described in more detail later on, a number of events, such as documents, agenda, data and the like, can be linked to a position, which will become available to the person when linking a person to the position.

Because of the implementation of the data model, in accordance with the present invention, it is based on a table of persons, possible to provide insight into which historical, current and future positions of a person are registered. From the table of groups the occupation or manning of the group can be determined immediately. If an functionary changes position, the permissions which belong to that do not have to be changed, since they are linked to the position, which is linked to the group instead of to the person, in accordance with the technology.

The temporary replacement of a position can be implemented in an easy way by linking another person to a position during the period of replacement. This can be implemented in a practical way by linking the permission to change the links of the other position-person to the position of ‘manager’ of the group. If the manager of, for example, a department is a busy person, such permission can be linked to a secondary functionary, for example to a secretary. An advantage of such a method is that the system administrator is not needed for the management of, for example, core data of the organisation. Another advantage is that the chance for errors by applying such a system in accordance with the present invention is notably lower than before, since the changes are entered by persons who are aware of the organisational reality and are therefore informed of all relevant facts in order to guarantee the correctness, timeliness and/or completeness of all data in the data set. Because of this, time-consuming and complex checking procedures do not have to take place.

In an initial preferred embodiment the data model comprises types of groups, positions and/or permissions that are defined in advance, with certain properties and/or attributes for providing a desired connection. An advantage of this preferred embodiment is that a basic interpretation that has been defined in advance can be supplied to the practical functioning within the data model. For example, by means of the types defined in advance, an organisation structure can be entered into a data model and displayed graphically in a manageable way; one or more types can be used for displaying the formal, hierarchical (vertical) structure, other types can be used for the horizontal groups such as projects and meetings, which can also comprise the cooperation with persons and groups outside the own organisation, whereas other types can be used for virtual groups, concerning those sets of persons and organisations that are relevant for the functional operation of an organisation, like, for example, client categories, dossiers, etc. Whereas the types have a fixed definition and implementation within this invention, additionally use can be made of labels that can be defined freely by the user of the system; on one hand the combination of types and labels provides the opportunity to work with a pre-defined and fixed implementation, and on the other hand a greater flexibility can be achieved by means of the labels.

In another preferred embodiment, the data model comprises data with regard to structures, which are sets of groups for storage thereof in the group storage space and/or a structures storage space. An advantage of the storage of groups in the group storage space is, for example, that within the storage space of groups, various hierarchies can be stored. These are subsequently linked by means of positions. Applicable here, for example, is that a position which can be called ‘owner’ has permission for creating a lower group. The owner of the higher group is then, for example, an even higher group, or finally an entity or person; with this the complete organisation can be described, stored and graphically displayed.

A further, higher level of a group within the data model concerns, for example, a conglomerate, being a set of structures. Data with regard to such conglomerates are preferentially stored inside the group storage space and/or conglomerate storage space.

In another preferred embodiment, the data model comprises data with regard to events, such as documents, e-mails and/or products that can be linked to positions, depending on the permissions that can be linked to the position. Such an event concerns, for example, a registered event in a space and time with regard to products, services, documents and finances. Examples of this are: sales, an appointment, an e-mail, etc. In connection with the data model in accordance with claim 1, data links can be made between persons, groups and events, with the accompanying advantages. The events can be linked to positions and the rights for creating and editing the events are also linked to the positions.

Preferably each set of entities is linked to an entity and/or group by means of a creation function. Another preferential function for linking a group to an entity is done by means of a management function. By applying a creation function it can be achieved that at all times it can be determined, based on the data model, the basis of which permission a group was created. Subsequently a hierarchy of groups can thus be reduced to the responsible person on the basis of the data model.

By means of the management function mentioned, modification rights can be granted and/or checked.

In another preferred embodiment, the data model comprises data with regard to societies, which are sets of entities and one or more conglomerates, structures and/or groups for the storage thereof in the group storage space and/or structures storage space and/or a society storage space, at which entities have direct positions within the society. With such an addition to the data model all persons and groups, and groups of groups as explained before, can be brought together in one set. Advantages of such a ranking include, among others, that for example, web portals can be linked to intranet markets or societies in which an infinite number of persons and organisations can cooperate and take action in an effective way. Elaborations of this are as follows. Since both groups, and groups and persons, can be linked mutually, a combined implementation of systems with business to end-user (consumer) (BTC) and, apart from that, business to business (BTB) becomes possible. A difference can hereby, for example, be made in an easy way between internal deliveries and external deliveries. Based on this form of the data model it becomes possible to create one web portal for authorised logging on, with which—based on this authorised log-on procedure—at the same time can be logged on to sites of underlying groups which are part of the society or market, for example by choice of each entity, which choice will then be visible in the personal displays.

In another preferred embodiment the method comprises steps for displaying data in a graphical representation which are related to an entity and its positions, groups, structures, conglomerates, societies, nations and/or supra-nationals and the positions thereof, on the basis of entering an instruction in one of the computers. Based on data from the data model, data can be displayed in an easy way and subsequently be interpreted. In such a graphical representation, the mutual relations between, for example, a department (group) within a company (structure) within a chain (conglomerate) can be displayed. Furthermore the functional relations can be displayed hereby, as well as all persons linked to that, with or without their contact data. Similar steps are possible for the society as a whole. Also, which positions a person holds within the society, both in the present, the past and in the (already known) future, can be displayed.

Such a graphical representation that can, for example, be displayed on a screen, will always be current by application of the previously described mode of operation, since there is, for example, no need to wait for the implementation of structural changes by the management department such as IT-departments of the companies concerned. An example of such a graphical representation that can be displayed on a screen is an organisation scheme based on data with regard to entities and/or one or more of the sets. Furthermore, functional relations between entities and/or one or more of the sets are preferably displayed, at which at least the same advantages apply.

Preferably the method in accordance with the present invention comprises steps for the, for example, registration of one or more statuses with regard to groups, by means of applying colour codes. An advantage of the registration of the status is that actions like creating, ending and archiving data with regard to sets (groups), can be linked to the permissions thereof. By means of this link, workflows can be created, for example, sequential actions that have to be carried out by various functionaries. Because of this it can, for example, be realised that a new group of a certain type can only be created by an administrator of an existing set, a new project can only be created, concluded and archived by means of entities with certain positions, a new event can be created by entities with certain positions, preferably in a pre-defined order or workflow.

In the data model storage spaces are preferably reserved for a start and end date, which can be registered with regard to entities, positions, permissions, groups and/or groups of groups, etc. The start and end date can also be linked to one or more statuses. An advantage thereof is that when an event, group or entity is ended, this can be done by assigning a end date to it. Subsequently all data with regard to the event, entity or group can remain stored, because of which an archiving function is built-in into the data model. In a similar way a planning function can be implemented in the data model, based on the start date.

Preferably an electronic message is defined as an event that is stored in the respective storage space, and the method furthermore comprises steps to provide a notification to entities, sets, structures which count as recipients and/or senders of the message. Subsequently the request actions with regard to the electronic message are preferably registered. An advantage of this is that the electronic message does not have to be sent itself—as is custom for e-mails in the current technological situation, whereas the notifications don't have to be sent, but that the shear recording of the message within the data set and making the notifications visible to each person concerned, suffices. Furthermore it is an advantage that by means of the linking of entities, such as persons, by means of positions to groups, groups of groups, etc., addressees can be selected in an easy way when sending electronic messages to or from groups, etc. Other advantages of this are that electronic messages can be linked to positions and the corresponding permissions of entities can be stored and retrieved; if desired, a signing permission for messages can, for example, be introduced as a result of this. Furthermore it is possible to provide messages with a status, which, if necessary, can be linked to a workflow, at which a difference can be made in draft versus final version, temporary versus permanent, unofficial versus official, etc., It is also possible to keep track of which entities have, for example, read the e-mail and/or answered it. Because of this, the data model furthermore provides an archiving function for storing e-mail messages. Another advantage is that messages on this basis within a society, as defined here, reduce the occurrence of Spam considerably, since the sender is, for example, known.

In another preferred embodiment, the method comprises steps for identifying an entity by means of a unique entity code (EURL), by means of a hierarchically arranged range of sub-codes with one sub-code per society and above-lying set, and a unique identification of the entity in the entity storage space as the lowest within the hierarchy. An advantage of such identification is that each entity can be identified in relation to the society to which it belongs. The data structure in accordance with the present invention comprises the seven mentioned hierarchical layers, which are the entities, the set, the structures, the conglomerates, the societies, the countries, and the supra-nationals. This being the case, the unique identification of the entities is subsequently created as a combination of the supra-nationals, the countries and the society to which it belongs, with the addition of an identification code of the person.

In a similar way, sets are identified in a unique way, based on a combination of the codes for the supra-nationals, the countries, the society, the conglomerates, the structures, and finally the code for the identification of the group itself. A further extension of this is a unique identification of a position, comprising the unique group code of the group to which the position is linked, together with a position code.

Advantages of the implementation of such coding can be found in the hierarchical structure of the coding. Because of this, it becomes possible to store data, with regard to all entities and groups at all levels, on one central computer system, or a number of sub-systems based on a standard.

Preferably the data model comprises data with regard to entity groups that can be created by entities based on positions, at which the entity group does not have hierarchical relations with the other groups. Such groups are therefore linked to persons, with the advantage that a person can have groups at his disposal within the data model which are not linked to a structure or conglomerate, whereas the person can make use of the structure of positions in accordance with the present invention. Another advantage is that an entity, for example a person, can create a total overview (for example as mentioned in claim 11) in which all personal activities and relations with other entities are visible, including the personal and group (possibly business) activities, both for the present, the past and the (already known) future.

In another preferred embodiment, the method comprises steps for the implementation of root registers for persons, positions, groups, sets of groups, etc. and/or legal persons that can be linked by means of the positions, based on the data model. Such root registers can, for example, be useful for government authorities as basic identification of persons, and, for example, sets such as companies. Such a root register provides a number of advantages, amongst which is the possibility to update and/or add the data and/or the structure on the basis of an identity by the entities and/or members of groups themselves.

Hereby it is, for example, possible to provide certain permissions to entities and/or sets of entities, such as banks, notaries, the land registry, communal basic administrations, schools, for example for diplomas, etc., so that these can function for the managing and/or verification of data. Another advantage hereof is that a multitude of registrations linked to persons and/or companies can be added to the root register by means of the new positions and/or events, because of which a multitude of separate databases can be prevented and the resulting un-timeliness, incorrectness and incompleteness can be avoided. Data with regard to a digital identification are preferably linked to data with regard to the persons and the legal persons. Hereby an authentication of the data is possible.

Another aspect of the present invention relates to a data model that comprises a data structure in accordance with the present invention.

Another aspect of the present invention relates to a data model comprising a data carrier and/or computer code for carrying out a method in accordance with the present invention.

Another aspect of the present invention relates to a system for the storage and accessing of data in a data model in accordance with the present invention, comprising one or more server computer systems that can be linked to a network, comprising processing means and storage means, comprising a number of storage spaces such as table or normalisations of tables. Such a system at least provides similar advantages as explained before.

Further advantages, characteristics and details of the present invention will be described below in further detail, referring to the attached figures, in which:

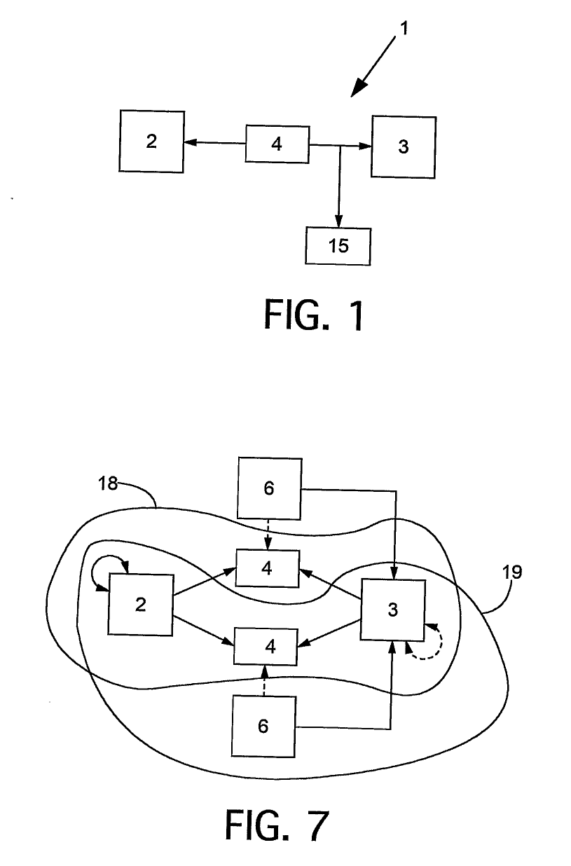

FIG. 1 is a schematic display of a data model in accordance with the first preferred embodiment, in accordance with the present invention;

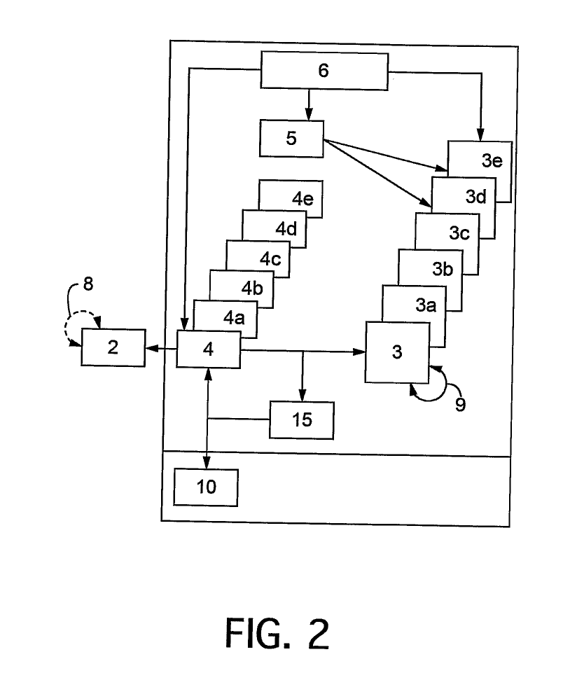

FIG. 2 is a schematic display of a data model in accordance with the second preferred embodiment, in accordance with the present invention;

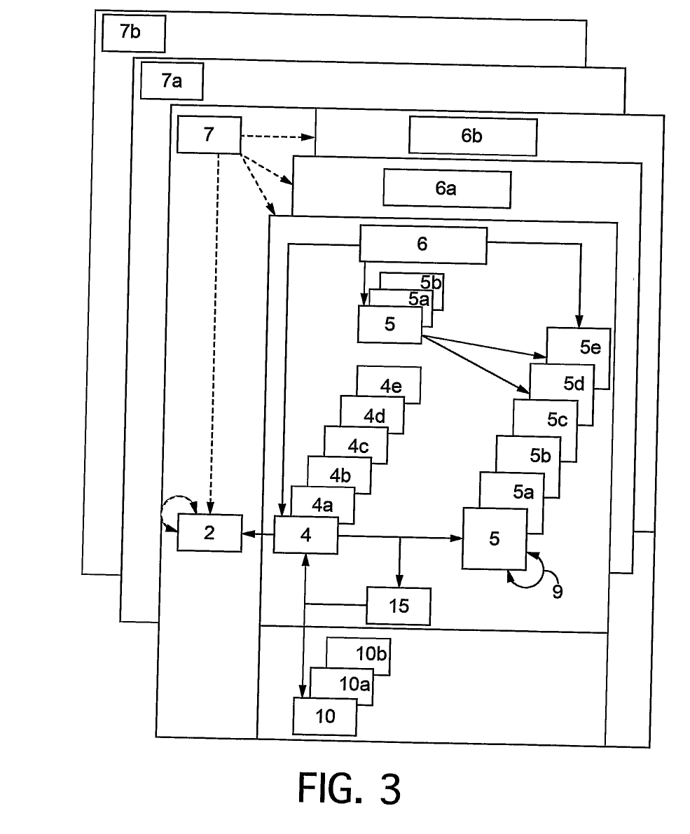

FIG. 3 is a schematic display of a data model in accordance with another preferred embodiment, in accordance with the present invention;

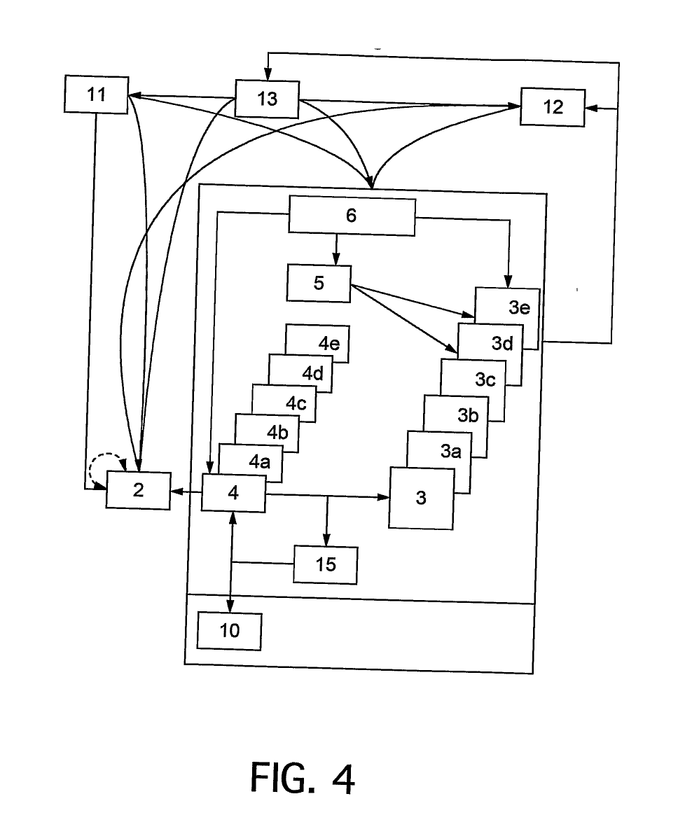

FIG. 4 is a schematic display of another preferred embodiment, in accordance with the present invention;

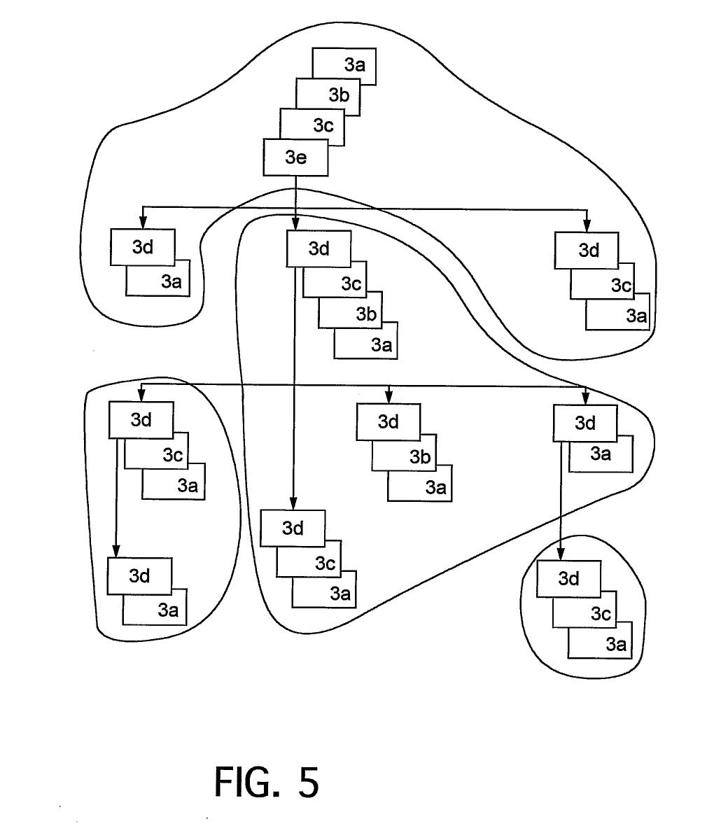

FIG. 5 is a schematic display of a graphic representation that can be created in accordance with the present invention;

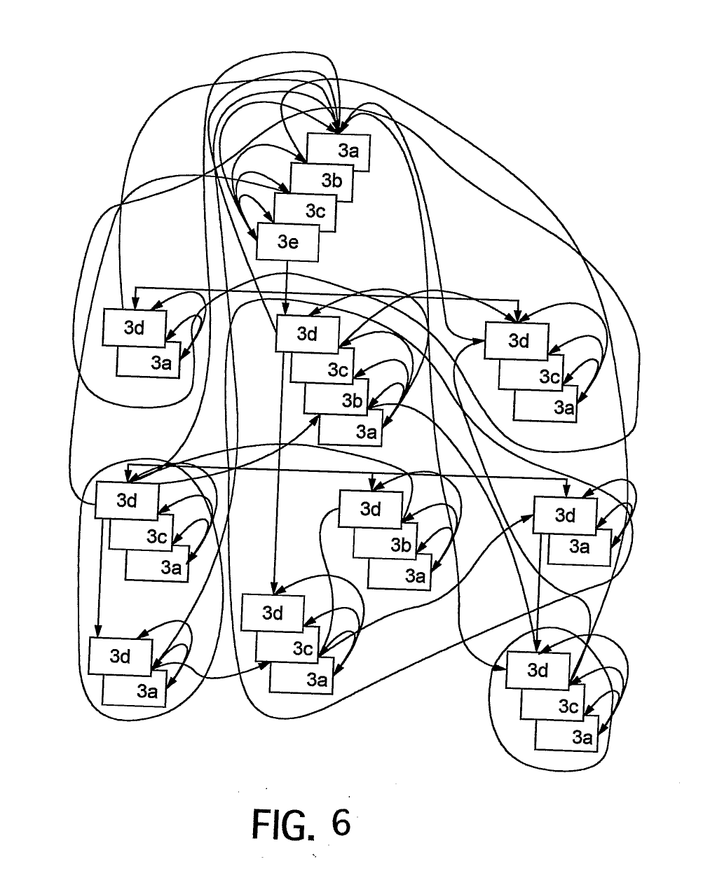

FIG. 6 is a schematic display of a graphic representation that can be created in accordance with the present invention;

FIG. 7 is a graphic representation of view points that can be realised by using a preferred embodiment, in accordance with the present invention.

A first preferred embodiment (FIG. 1) in accordance with the present invention relates to a schematically displayed data model 1. In this data model a storage space 2 is provided for storing data with regard to entities 2, such as persons, manufacturers or other objects on which information should be stored. The data space for storing this data is preferably a table or a normalisation thereof. A normalisation of a table comprises a number of tables that is known by itself, which is, for example, defined in an object-oriented or relationally oriented way. Hereby data redundancy can be avoided in a way known in itself.

Furthermore a data space is provided for the storage of data with regard to sets of entities which will in this text also be referred to as groups. Such groups are related to definition issues that depend on the type of entity. If the entities are persons, the groups concern the groups of persons. If the entities are houses, the groups, for example, concern streets, (city) blocks, cities, regions, provinces, countries and/or continents. If the entities are related to persons, the groups are, for example, related to meetings, staff members of departments, companies of groups of companies, participants in projects, inhabitants of addresses, streets, city blocks, cities, regions, provinces, countries or continents respectively, etc. Preferably the data, with regard to properties of groups, are stored in a table with a normalisation thereof, comprising a number of tables. In accordance with the present invention, a summary of the members when storing the properties of a group are, for example, avoided. In accordance with the present invention, the members are linked to a group by means of a function 4 which is stored in another storage space in the data model 1.

At a position, what the position means is stored, to which the function belongs to set 3, and to which person or group is holding the position. Here it is by preference possible that a position can be created and maintained without a person being linked to the position. Within the data model the positions are preferably created within a group or linked to a group. Applicable here is that many positions can be linked to one group. Furthermore, one entity can be linked to many positions. Because of this it is possible to link many entities to many groups.

The linking or changing of a link of a position within a group can be carried out in an easy manner, by adding the entity or adding another entity instead of the existing entity to the position. An advantage of this is, furthermore, that this so-called functionary, by linking the entity or a person to a position automatically, has all permissions at his disposal that belong to the position.

This is related to the linking of permissions 5 of the position 4 which belongs to the group 3. By linking the permissions to the position linked to the group, it becomes possible to realise the mentioned link of the functionary to a position.

A number of further advantages of such a data model are as follows. The permissions belonging to a position can be maintained and do not have to be changed when a personal interpretation of a position is changed. It becomes possible, based on a start and end date linked to an entity, position, group or permission, to display all historical, current and future positions of a person, on the basis of one entity table. Based on the table of groups it is in a similar way possible to easily retrieve all persons linked to a group by means of a position.

FIG. 2 displays a schematic specification of another preferred embodiment of the data model. In this data model additional entity groups 8 are stored. Such entity groups or personal groups do not resort under the basic model as described in FIG. 1. At this an entity, for example a person, can on the basis of positions store personal projects, meetings or activities in the data file, which are not linked to formal groups. By means of such an extension, a person can apply his own information that does not resort under permissions from groups.

Groups can have functional relations with other groups; this is indicated by means of arrow 9. A group can erect a further group, such as a meeting. Furthermore, a group that represents a parent company can hold a position in a subsidiary company, like being the founder or holding a certain authority.

Certain standard types of positions are preferably applied in relation to the data model. Examples hereof are the owner who initiates, approves, reviews or cancels the existence of a group and who decides on the administrator of a group. The administrator is the functionary who subsequently manages the group. The administrator has, for example, permission for the appointing of a secretary, members and consultants of a group. A secretary is, for example, provided with the authority that is equal to the administrator's for the use thereof during his absence. A member and/or consultant of a group can be defined as standard types with corresponding authorities, for example, initiating an event such as sending a message. Advantages of such standard types of positions include that it becomes immediately clear to users of systems using such a data model, which authorities are allocated to which positions.

In a similar way as for positions, it is possible to define standard types of groups. Furthermore it is possible to use so-called labels, which are types of groups and/or positions that can be freely defined by the users. An example of a group is a unit 3D that can, for example, be defined within a formal hierarchy of a company as a group with only employees. Another standard type group can be a project 3C. A project is a sub-group of a unit with a specific task and a planned end date. It is thus possible that in an example of a standard type project persons who are not employees of the company also hold positions within the group. Another example of a group is a meeting 3B. A meeting is defined as a discussion structure that can be recognised as such, of one or more planned meetings that formally resort under a unit or project.

Furthermore, an example of an event 10 is a planned meeting 10a that can be defined as an event as a position of a group ‘meeting’. One or more members of the group ‘meeting’ have the authority to initiate such an event and/or store it in the data model. Another example of an event is an appointment 10b that can be stored on the basis of a position between two or more persons from the table of persons, based on a position.

Furthermore, an aspect of this preferred embodiment is storage room for events 10 which are linked to positions 4. Permissions 5 can be linked to positions for creating or modifying the events. Such events can be stored with regard to products, services, documents and finances. Examples hereof are storage of purchasing/selling activities, appointments or messages, or e-mails. A special advantage of the latter is that messages can be stored as an event and therefore do not have to be sent, but that it suffices to send a notification to a person or a number of persons of a group or combination of group, that such a message is available for reading. Thus it becomes, for example, possible for the sender to track which messages have actually been read, without the computer of the recipient having to send a message.

Furthermore, the group types ‘structure’ 5 and group types ‘conglomerate’ 6 have been added to the data model (FIG. 3). A structure is hereby a set of one or more groups. An example hereof is a number of departments within a company or a number of subsidiary companies within a chain. Underneath, structures will also be referred to as organisations. The data of a structure are preferably stored in the same data space as that of the groups. A structure is a differentiation of a group, namely a set of groups.

Another differentiated form of groups is a conglomerate 6. A conglomerate can have functional relations with groups, organisations and persons. A practical example of a conglomerate is a company with several departments (structures) or a chain with several structures (subsidiary companies). Within such subsidiary companies groups can be defined that represent meetings, projects or otherwise defined cooperating groups of persons, at which is important that all types of groups or sets of groups can be stored in the data space of the groups, or preferably in the table or the normalisation thereof of the groups.

Apart from the underlying layers of groups such as the groups, structures, conglomerates and markets or societies, further layers are possible. One could hereby think of countries and/or supra-national organisation that constitute groups of hierarchical lower markets or countries respectively. From these the data can also be stored in a data space for the groups. A difference is hereby made between the group type society, country and supra-national on one hand, and the conglomerates and structures and groups on the other hand. The difference is made by the fact that markets are a set of one or more conglomerates and the persons who are part of the market, whereas the groups, structures and conglomerates are linked to persons via position and corresponding permissions. Persons can, for example, be an owner of a conglomerate (chain), structure and/or group, whereas a person can not be an owner of a market, country or supra-national. The definition, as determined in this technology, corresponds to the social reality.

Based on this structure, it becomes possible to mutually connect various separate web portals into combined intranet markets, at which the persons and the groups can act and proceed in an efficient way. Here it applies, for example, that, as has been indicated before, both business to consumer and business to business possibilities exist because of the direct set of the markets and the persons.

An example of an entity identification code (PURL; personal URL) is in the present invention, for example, composed from a code for a country, a code for a market and a code for the person therein. Hereby, for example, a code for a supra-national organisation can be inserted at the highest hierarchical location. In a similar way a concrete group identification code (GURL; group URL) can be constructed from the country code, the market code, the conglomerate code, the structure code and the group code. The positions linked to the groups can also be uniquely identified by adding a position code to the group code.

Furthermore it is possible to supply events such as products, services, documents, messages, addresses, locations, movable and immovable goods, bank accounts, accountings and the like with their own identification code that can be linked to one of, the codes mentioned for deducting the origin of the event (creator and/or owner). Hence a start and end date can be applied. Hereby a difference can be made between authenticated and non-authenticated data. A passport, for example, counts as authenticated data, based on a certain authority.

Based on the previous, a global society can be mapped and/or administered. It becomes possible, in a very simple way, to display relevant data graphically with regard to entities, groups or events that are related to one other. Examples hereof are given below. If all such systems in the world are mutually linked and/or would be constructed in accordance with the present invention, the necessity of the code level of the supra-national in the entity coding and the group coding becomes defunct. Until such time, this level of coding can be used for the indication of the coding systems in use for facilitation, possible later normalisation and facilitating data exchanges between the systems that will be linked by means of the coding of this level.

Such a system offers solutions for the limitations of, for example, the known CRM-systems that are not suited in case a client in one situation can be the supplier and in another situation can also be the employee, shareholder and the like. A system in accordance with the present invention enables total relation management. Furthermore, it is possible in a system, in accordance with the present invention, to register complete organisations of persons and organisations, which enables co-creating between persons, organisations and government authorities. Amongst others, co-creation is related to trade and distributive trade, as well as to the creation and management of documents, publications, websites and web logs. Amongst others, because events are linked to both groups and persons, the identification, document management, verification and archiving are strongly simplified.

In FIG. 4 the preferred embodiment of FIG. 2 is displayed, with the addition of the structure of three basic registers (root registers). The first basic register relates to the basic register 11 of natural persons. The data of this basic register can be stored in the table of the entities of the implementation for of FIG. 2.

A further basic register 12 relates to legal persons. The data, with regard to the legal persons, can be stored in the table of the groups 3. The basic register of legal positions 13 (legal functions) comprises in a logical way the data that can be stored in the table of the positions 4 of the implementation form. It therefore becomes possible to register the identity of persons on the basis of legal requirements or an achieved reputation. It becomes furthermore possible to register the correctness of positions and the authenticity of objects and rights or permissions in the society. It is, for example, possible to link the data of the personnel administration of the various cities and towns to this table or this basic register 11 (root register). If the reliability level of the government data is not available, a trust level can be introduced on the basis of subjective experiences of entities and/or groups with each other. The reliability level can hereby be determined by means of the trust that is put in a known entity that entered that data. The authenticity of the entity that enters can thus be based on data from the basic register 11. Because of this it becomes, for example, possible that the registration of persons, organisations and positions that are registered in the known way in incomplete trade registers, are kept more completely. The reason for this is that the persons can maintain the data themselves and have an interest in doing so and therefore will do so. The interest can, for example, be shown in the participation in the society. Parts of the root registers can, for example, be authenticated by reliable parties such as banks, notaries, schools (for example for diplomas), land registries and the like. If it is indicated that data were authorised by such a party, a certain amount of reliability can be given to this, on the basis of which the data can be used.

The previous provides a number of advantages. One advantage is that by the authentication or the known reliability of the data, the coherence within the society is strengthened, as a result of which the trust, which is the basis for each economy, can be strengthened. Furthermore, the application of the previous solutions provides precision in the society. It is efficient that a separate database does not have to be constructed for every desired registration with all personal data etc., but that a virtual group can be created within the system in accordance with the present invention, at which positions and permissions take care of the linking to the respective data in the basic registers (root registers). Such a method provides huge savings for, for example, government authorities and other suppliers of basic information, and existing, authenticated information can be reused. Furthermore the identification can be strengthened by application of the basic registers during participation in the society, which can be applied to the fight against terrorism.

FIG. 5 shows an example of a graphic display that can be created on the basis of data within the data model. The displayed tree structure, for example, represents the organisational structure of a conglomerate 6 comprising a number of groups 3a-3e. The vertical structure of the organisation is hereby displayed. The so-called route of the organisation is the holding 3e. At this level there are a number of groups, such as a project 3c, a meeting 3b and a freely definable group 3a (virtual group). On the underlying level there are a number of (company) units 3d with, behind that, other different groups such as a virtual group 3a, a meeting 3b, and a project 3c.

This pattern repeats itself in the underlying levels. The holding 3e is the root of the complete conglomerate 6. In this implementation example the conglomerate 6 comprises 4 structures: 5, 5a, 5b, 5c. The unit 3d within structure 5a is the root of the structure 5a. The owner and/or creator of this root 3d within 5a is the holding 3e. Within this conglomerate the holding 3e ranks the highest. Practically seen, the group holding 3e comprises a number of entities or persons which each holds specific positions within this group 3e. This includes the positions of administrator and owner.

The owner can be an independent entity, but also an entity that holds a position in a market that is ranked above the conglomerate. One of the functionaries within the holding 3e is, in a similar way, the owner of the unit 3d of the underlying structure 5a. In this way there is always an owner at a higher level. Furthermore, a structure always has its own root, which by itself is again owned or created by a higher ranked group, or in the case of the root of the conglomerate, a group or entity. Within this conglomerate there are therefore four structures at which the underlying structures 5a, 5b, 5c each has a root 3d within 5a, 5b, 5c. An organisation can in such a way be graphically displayed on the basis of data from the data model.

In FIG. 6 the hierarchical structure of the conglomerate 6 of FIG. 5 is displayed. The underlying positions belonging to the groups and/or entities and groups are hereby displayed. Such positions can indicate that employees of a unit are partaking in projects linked to them. Some of such lines reach the border of the display, which indicates that persons from outside the conglomerate are partaking in such projects. There are furthermore lines that indicate, for example, a unit that employees from this unit partake in certain meetings. It is hereby also possible that persons from outside the conglomerate are partaking in these meetings. Such external positions display the openness of a conglomerate.

A method in accordance with the present invention can be carried out by means of a computer or a number of computers that are mutually linked to each other by means of a network. The data can be stored on storage devices inside or linked to these computers and the modifications for storing them in accordance with the data model, in accordance with the present invention, and the creation of graphic representations for the easy interpretation of the data, in accordance with the data model, can be carried out by processors of such computers. Here applies that, amongst others, because of the structure of the data model, the data can be displayed in a way that is easy to modify and to read, and which leads to profitable ways of interpretation thereof in ways that are not possible, given the current technology.

In the previous the present invention is described by means of some preferred embodiments. Several aspects of several implementations are considered to be described in combination thereof, at which all combinations that can be made on the basis of this document by an expert, should be co-read. These preferred embodiments are not limited to the data privacy scope of this text. The requested rights are defined in the attached claims.

1. A method for storing, by means of one or more computer systems that can be mutually connected, each comprising processing means and storing means comprising a number of storage spaces, such as table or normalisations of tables, and accessing data in a data model, comprising steps for:
providing a data processing environment for carrying out the method by means of computer systems that can be mutually linked;
providing the data model;
providing access to one or more of the computer systems that can be mutually linked, where the data model comprises:
data with regard to entities, such as persons, for the storage thereof in an entity storage space;
data with regard to sets of entities, for the storage thereof in a group storage space;
data with regard to positions, such as roles or tasks, for the storage thereof in a position storage space, where a position is related to a group, being a set of entities and where the data with regard to a position comprises:
at least one e-f-data space for an entity for the linking of the position to an entity, and
at least one g-f-data space for a group for the linking of the position to a group;
data with regard to permissions, such as logical activities applicable to changing, creating or deleting, which are related to positions for the storage thereof in a permissions storage space.

2. The method in accordance with claim 1, wherein the data model comprises pre-defined types of groups, positions and/or permissions with pre-defined properties and/or attributes, for providing a desirable coherence.

3. The method in accordance with claim 1, wherein the data model comprises data with regard to structures, being sets of groups, for the storage thereof in the group storage space and/or a structures storage space.

4. The method in accordance with claim 1, wherein the data model comprises data with regard to conglomerates, being sets of structures, for the storage thereof in the group storage space and/or a conglomerates storage space.

5. The method in accordance with claim 1, wherein the data model comprises data with regard to events, such as appointments, meetings, documents, e-mails, products, which can be linked to positions depending on the permission that can be linked to positions.

6. The method in accordance with claim 1, wherein each set of entities is linked to an entity and/or group by means of a creation function.

7. The method in accordance with claim 1, wherein each group is linked to an entity by means of an administrative function.

8. The method in accordance with claim 1, wherein the data model comprises data with regard to societies, being sets of entities, and one or more conglomerates, structures and/or groups, for the storage thereof in the group storage space and/or a society storage space, where entities hold direct positions within the society.

9. The method in accordance with claim 1, wherein the data model comprises data with regard to nations, being sets of societies, for the storage thereof in the group storage space and/or a nation storage space.

10. The method in accordance with one claim 1, wherein the data model comprises data with regard to supra-nationals, being sets of nations, for the storage thereof in the group storage space and/or a further storage space.

11. The method in accordance with claim 1, further comprising steps for displaying data in a graphical representation which concern an entity and its positions, groups, structures, conglomerates, societies, nations and/or supra-nationals, and the positions thereof on the basis on an entry of an instruction in one of the computers.

12. The method in accordance with claim 1, further comprising steps for displaying an organisational scheme on screen, on the basis of data with regard to entities and/or one or more of the sets.

13. The method in accordance with claim 1, further comprising steps for displaying functional relations between entities and/or one or more of the sets on screen.

14. The method in accordance with claim 1, further comprising steps for registering one or more statuses with regard to groups.

15. The method in accordance with claim 1, wherein in the data model for the entities, sets of entities, positions, groups, groups of groups etc. and/or permissions, a start date and an end date can be registered in the respective storage space.

16. The method in accordance with claim 5, further comprising steps for the definition of an electronic message as an event that is stored in a respective storage space, and steps for providing a notification to entities that count as recipients of the message.

17. The method in accordance with claim 15, further comprising steps for the registration of the retrieval of an electronic message based on a notification.

18. The method in accordance with claim 6, further comprising steps for providing a workflow for, for example, editing data while using colour codes with regard to the status of an entity by an entity, with a creation function or an administrative position.

19. A method in accordance with claim 1 for identifying an entity by means of a unique entity code (EURL), by means of a hierarchically arranged range of sub-codes with a sub-code per society and higher-ranking set and a unique identification of the entity in the entity storage space as the lowest within the hierarchy.

20. A method in accordance with claim 1 for identifying groups by means of a unique group code (GURL), by means of a hierarchically arranged range of sub-codes with a sub-code per higher-ranking set and a unique identification of the group in the group storage space as the lowest within the hierarchy.

21. The method in accordance with claim 20, further comprising steps to identify positions at sets of identities by means of a unique position code (PURL), where this position code comprises the sub-codes of the group code and an additional position code for the identification of the position within the group.

22. A method in accordance with claim 1 where the data model comprises data with regard to entity groups that can be created by entities on the basis of positions, where an entity group does not have hierarchical relations with other groups.

23. The method in accordance with one claim 1, further comprising steps for the implementation of root registers for persons, positions and/or legal persons that can be linked by means of the positions based on the data model.

24. The method in accordance with claim 23, further comprising steps for the linking of data with regard to a digital identification and/or verification of the data with regard to the persons, positions, groups, groups of groups, etc. and legal persons.

25. A data model comprising a data structure as recited in claim 1.

26. A data carrier comprising a data model and/or computer code for carrying out the method in accordance with claim 1.

27. A system for the storage and accessing of data in a data model in accordance with claim 1, comprising one or more server computer systems that can be linked to a network, comprising processing means and storage means, comprising a number of storage spaces such as tables or normalisations of tables.
